(19) United States
(12) Patent Application Publication
(10) Pub. No.: US 2018/0211737 A1
(43) Pub. Date: Jul. 26, 2018

(54) GALLIUM-69 ENRICHED TARGET BODIES

(71) Applicant: Mallinckrodt Nuclear Medicine LLC, St. Louis, MO (US)

(72) Inventors: David Pipes, Wildwood, MO (US); William Uhland, St. Charles, MO (US)

(21) Appl. No.: 15/878,756

(22) Filed: Jan. 24, 2018

Related U.S. Application Data
(60) Provisional application No. 62/449,642, filed on Jan. 24, 2017.

(51) Int. Cl. G21G 1/10; B32B 15/01; C22C 28/00; C25D 3/56

(52) U.S. Cl. CPC G21G 1/10; B32B 15/01; G21G 2001/0094; C25D 3/56; C22C 28/00

(57) ABSTRACT

Gallium target bodies for producing germanium-68 are disclosed. The targets include an alloy of a base metal and gallium. The alloy is enriched in gallium-69 to increase germanium-68 production. Methods for producing such alloys by electroplating are also disclosed.

### CROSS-REFERENCE TO RELATED APPLICATION

This application claims the benefit of U.S. Provisional Patent Application No. 62/449,642, filed Jan. 24, 2017, which is incorporated herein by reference in its entirety.

### FIELD OF THE DISCLOSURE

The field of the disclosure relates to target bodies for producing germanium-68 that are enriched in gallium-69 and, in particular, gallium-69 enriched alloys.

### BACKGROUND

Positron emission tomography (PET) is an in vivo imaging method that uses positron emitting radiotracers to track the biochemical, molecular, and/or pathophysiological processes in humans and animals. In PET systems, positron-emitting isotopes serve as beacons for identifying the exact location of diseases and pathological processes under study without surgical exploration of the human body. With these non-invasive imaging methods, the diagnosis of diseases may be more comfortable for patients, as opposed to the more traditional and invasive approaches, such as exploratory surgeries.

One such exemplary radiopharmaceutical agent group includes gallium-68 (Ga-68), which may be obtained from the radioisotope germanium-68 (Ge-68). Ge-68 has a half-life of about 271 days, decays by electron capture to Ga-68, and lacks any significant photon emissions. Ga-68 decays by positron emission. These properties make Ge-68 an ideal radioisotope for calibration and transmission sources. Thus, the availability of the long-lived parent, Ge-68, is of significant interest because of its generation of the shorter-lived gallium radioisotope.

Germanium-68 may be obtained by irradiating a target body containing gallium to cause gallium-69 within the target body to transmute to germanium-68 by a (p, −2n) reaction. Conventional gallium target bodies contain gallium-69 in an amount found in its natural environment (60%) with the remainder being gallium-71. As pure gallium has a relatively low melting point, gallium is often alloyed with other materials to increase the melting point and stability of the material.

A need exists for improved materials for use in target bodies for producing germanium-68 including materials that increase the yield of germanium-68, that are cost-competitive and that are relatively stable at temperatures typical of the irradiation process.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a target body for producing geramium-68. The target body includes a target substrate plate and an alloy that forms an interface with the substrate plate. The alloy comprises gallium. Greater than 60% of the gallium is gallium-69. The alloy also includes a base metal selected from the group consisting of nickel, iron, cobalt, copper and tungsten.

Another aspect of the present disclosure is directed to a method for forming a target body. The method includes contacting a target substrate plate with a plating bath comprising a base metal selected from the group consisting of nickel, iron, cobalt, copper and tungsten. The target substrate plate is contacted with a plating bath comprising gallium. At least 60% of the gallium is gallium-69. Nickel and gallium-69 are electroplated onto the target substrate plate to form an alloy of base metal and gallium-69.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a cross-section side view of a gallium-69 target body for producing germanium-68;

FIG. 2 is a perspective front view of the target body;

FIG. 3 is a perspective rear view of the target body;

FIG. 4 is a schematic of a particle accelerating system; and

FIG. 5 is a schematic of a cyclotron of the particle accelerator system.

Corresponding reference characters indicate corresponding parts throughout the drawings.

### DETAILED DESCRIPTION

Provisions of the present disclosure relate to target bodies that include an alloy of a base metal and gallium. The gallium is enriched in gallium-69 isotope relative to the amount of gallium-69 present in natural gallium. Methods for forming the target body enriched in gallium-69 and methods for producing germanium-68 by irradiating such targets are also provided.

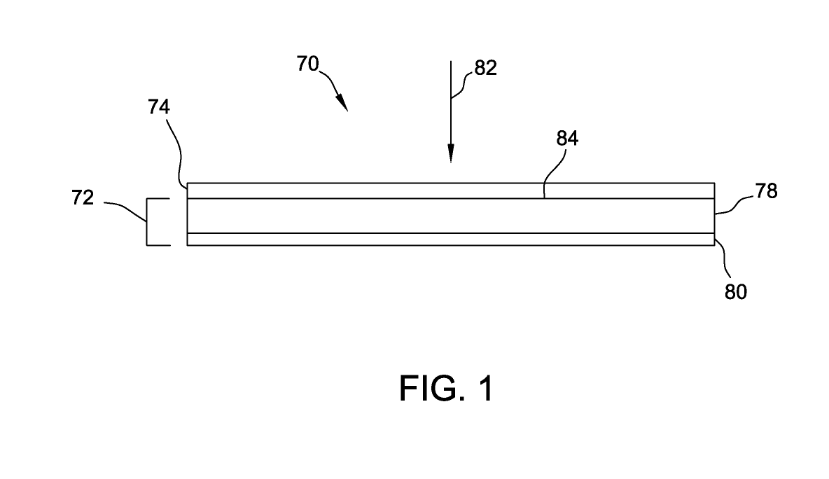

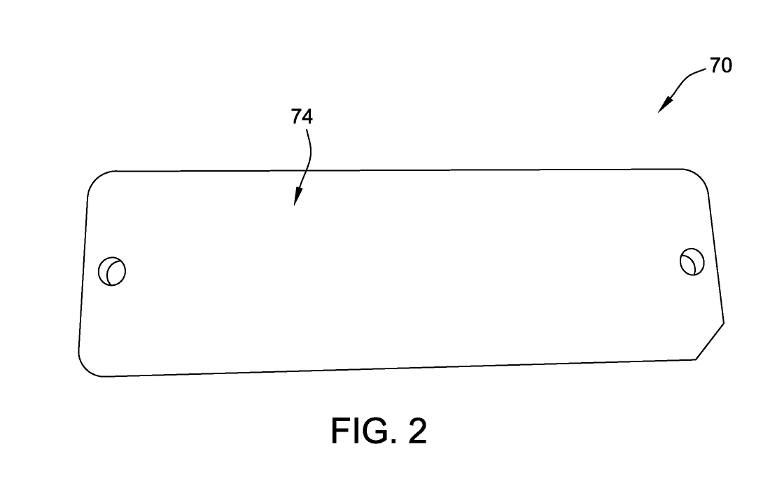

A solid target body suitable for producing germanium-68 is generally referenced as “70” in FIGS. 1-3. The target body 70 may suitably be used during the bombardment process to produce germanium-68 from gallium.

The target body 70 includes a surface layer 74 (FIG. 1) which is irradiated by charged particles (indicated generally by arrow 82) to produce germanium-68. The surface layer is supported by a target substrate plate 72. The plate 72 of the target body 70 may include a substrate metal, such as copper, aluminum, nickel and/or other conductive material(s). In some embodiments, the metal is copper. The plate 72 may include two or more layers with the intermediate layer 78 contacting the surface layer 74 being the substrate metal. For example, the base layer 72 may be molded out of a supporting layer 80 (e.g., supporting aluminum layer 80) and then coated with the intermediate layer 78 (e.g., copper immediate layer 78).

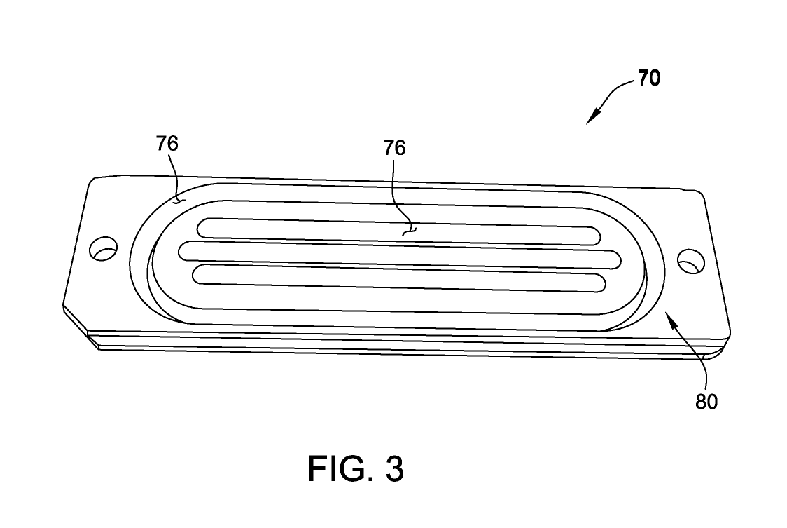

Being conductive, the substrate plate 72 of the target body 70 may be adapted to transfer heat efficiently away from the target body 70 as temperature increases while the target body 70 is irradiated. One or more cooling channels 76 (FIG. 3) may be formed in plate 72 for cooling during irradiation. The cooling channels 76 facilitate fluid flow along the target body 70 so that heat may be removed from the target body 70 while the target body 70 is irradiated with charged particles.

As illustrated in FIG. 1, the surface layer 74 is positioned on a front or top surface of the target body 70. In other embodiments, the surface layer fully surrounds the substrate plate 72.

The target body 70 of embodiments of the present disclosure may be produced by depositing an alloy material (FIG. 1) on the target substrate plate 72 to form the surface layer 74. The alloy is made of gallium and a base metal. In accordance with the present disclosure, the gallium in the alloy is enriched in gallium-69 (i.e., contains gallium-69 in an amount greater than the amount present in natural gallium (60.11% on an atomic basis)). The base metal is selected from the group consisting of nickel, iron, cobalt, copper, tungsten and combinations of these metals. In some embodiments, the base metal is nickel.

The base metal is electroplated onto the substrate plate with gallium. The gallium-base metal alloy may be electroplated by depositing both gallium and the base metal from an electroplating solution or “bath”. In other embodiments, gallium and the base metal are separately electroplated. In such embodiments, after deposition, gallium and the base metal migrate between the deposited layers to form the alloy material. After deposition of the alloy material, the alloy forms an interface with the target substrate plate 72 (i.e., substrate plate-alloy interface).

In embodiments of the present disclosure, the alloy enriched in gallium-69 is deposited by electroplating. The target substrate plate 72 is contacted with a bath that contains gallium-69 to electroplate gallium-69 onto the substrate. The electroplating bath may also contain an amount of isotopes other than gallium-69 (e.g., gallium-71). In such embodiments, the electroplating bath contains gallium-69 in an amount greater than the amount present in natural gallium (60.11% on an atomic basis). For example, in some embodiments, at least about 65% of the gallium in the gallium bath is gallium-69, or at least about 70%, at least about 80%, at least about 85%, at least about 90%, at least about 95% or even at least about 99% of the gallium in the gallium bath is gallium-69.

In embodiments in which the electroplating bath comprised both gallium-71 and gallium-69, the molar ratio of gallium-69 to gallium-71 may at least about 1:1 or, as in other embodiments, at least about 2:1, at least about 3:1, at least about 4:1, at least about 5:1 or even at least about 9:1. In some embodiments, the gallium in the bath consists essentially of gallium-69 isotopes (i.e., contains other isotopes in an amount consistent with current isotope enrichment techniques which may be from 80-95% pure). Enriched gallium may be purchased commercially in solid or liquid forms.

Gallium enriched in gallium-69 isotope may be deposited by known methods for electroplating natural gallium including, for example, as described in U.S. Pat. Nos. 7,951,280 and 7,507,321 and/or U.S. Patent Pub. No. 20120055612, each of which is incorporated herein by reference for all relevant and consistent purposes.

In accordance with embodiments of the present disclosure, a plating bath is prepared. The target substrate plate 72 is contacted with the plating bath and a current is applied to deposit gallium from the bath and onto the plate 72. In some embodiments, the bath is only contacted with a top surface 84 of the plate 72.

The plating bath (i.e., electrolyte bath) contains a source of gallium that is enriched in gallium-69. The source of gallium may include various gallium salts such as gallium halides (GaF₃, GaCl₃, GaBr₃, GaI₃), gallium perchlorate (Ga(ClO₄)₃), gallium sulfate (Ga(SO₄)₃), gallium nitrate (Ga(NO₃)₃), gallium phosphate (GaPO₄) and various gallates. The concentration of gallium (all isotopes) in the plating bath may be at least about 0.0001 M, at least about 0.001 M, at least about 0.01 M, at least about 0.1 M at least about 1 M, at least about 3 M or even at least about 5 M or more (e.g., from about 0.0001 M to about 6 M or form about 0.1 M to about 6 M). As gallium is consumed by being deposited on the substrate plate 72, the plating bath may be replenished with the source of gallium during or after plating.

The plating bath may be maintained below ambient temperatures (e.g., below about 30° C., below about 25° C., below about 20° C., or even below about 10° C.) due to the relative low melting point of gallium of about 30° C. The plating bath may be aqueous and/or may include other solvents (e.g., methanol such as in a 50:50 molar ratio of water to methanol or other organic solvents) to allow the temperature of the bath to be reduced to below about 0° C. (e.g., less than about −10° C., less than about −25° C. or even less than about −50° C.). The plating bath may include organic solvents which may be used as an alternative to water or may be used in combination with water as a solvent. Other solvents include, for example, amides, alcohols, acetonitriles and glycerin.

The plating bath may include various electrolytes and/or buffers such as organometallic compounds and various acids, bases (e.g., hydroxides) or salts to increase the conductivity of the plating bath. Additional materials that may be used in the plating bath include various complexing agents such as citrates, tartrates, EDTA and glycine. Various pH adjusting agents may be added to achieve a target pH in the bath.

The electroplating bath may be acidic with a pH less than 5 or even less than 3. In other embodiments the bath is basic with a pH of greater than 9 or even greater than 12. Current densities in the bath may be from about 3 mA/cm² to about 50 mA/cm².

A base metal such as nickel is also electroplated onto the substrate plate with gallium. The base metal may be included in the same solution from which gallium is electroplated or the base metal may be in a separate solution and the gallium and base metal are electroplated in succession.

When nickel is the source of base metal, the source of nickel may be nickel salts (e.g., nickel sulfate (NiSO₄(H₂O)₆), nickel chloride (NiCl₂), nickel nitrate (Ni(NO₃)₂) and nickel ammonium sulfate (Ni(NH₄)₂(SO₄)₂). In some embodiments, the nickel plating bath also includes boric acid (e.g., at least about 0.01 M, at least about 0.1 M or from about 0.01 M to about 3 M or boric acid).

Generally, nickel may be plated with gallium under the reaction conditions provided above relating to gallium deposition. If plated separately, nickel may be plated at relatively higher temperatures such as from about 25° C. to about 100° C. or from about 25° C. to about 70° C. Relatively high current densities may also be used (e.g., from about 5 mA/cm² to about 150 mA/cm² or from about 25 mA/cm² to about 125 mA/cm²). Nickel plating may be performed according to the methods disclosed in “Electrodeposition of Nickel,” Modern Electroplating (5^{th}), 2010, pp. 79-114), which is incorporated herein by reference for all relevant and consistent purposes.

In embodiments in which base metals other than nickel are used to form the base metal-gallium alloy (e.g., iron, cobalt, copper or tungsten), the base metal may be deposited by electroplating according to any of the known methods available to those of skill in the art for deposition of such metals.

In embodiments in which a bath of base metal and a bath of gallium-69 are separately contacted with the substrate plate 72, each bath may be contacted with the plate and electroplated any number of suitable times to form the base metal-gallium alloy. For example, a base metal bath and a gallium bath may be used in succession in 2 cycles, 3 cycles, 4 cycles or more. When separate layers of base metal and gallium are deposited, it is believed that the atoms in the various layers migrate to form an alloy material.

The deposited surface layer (and each deposited gallium and base metal layer if deposited separately) may be relatively thin and even deposited as a thin film of material. The surface layer (and any deposited sub-layer of gallium or base metal) may have a thickness of less than about 1 mm, less than about 500 μm, less than about 1 μm or even less than about 500 nm (e.g., from about 25 nm to about 1 mm, from about 50 nm to about 500 μm, from about 50 nm to about 1 μm or form about 50 nm to about 500 nm). In some embodiments of the present disclosure, electroplating of base metal and gallium may cause from 0.01 grams to about 6 grams of alloy to deposit on the target substrate plate 72 (e.g., from about 0.5 grams to 4 grams of alloy target material).

It should be noted that the methods described herein for forming the gallium-69 enriched surface layer 74 (and each sub-layer if base metal and gallium-69 are deposited separately) are exemplary and other parameters and methods that result in formation of a gallium-69 enriched surface layer may be used unless stated otherwise.

The resulting alloy surface layer 74 formed by electroplating is an alloy of the base metal (e.g., nickel) and gallium. The alloy contains an amount of gallium-69 (relative to gallium-71) that corresponds to the amount in the electroplating bath. The alloy is enriched in gallium-69 in that greater than 60% of the gallium in the alloy is gallium-69 (e.g., at least about 65%, at least about 70%, at least about 75%, at least about 80%, at least about 85%, at least about 90%, from about 60% to about 99% or from about 65% to about 99% of the gallium in the gallium bath is gallium-69). The molar ratio of gallium-69 to gallium-71 in the alloy may be at least about 1:1 or, as in other embodiments, at least about 2:1, at least about 3:1, at least about 4:1, at least about 5:1 or even at least about 9:1.

Generally, the alloy surface layer 74 may contain an amount of base metal that allows the alloy to be heat stable during irradiation. In some embodiments, the alloy contains at least about 25 wt % base metal or at least about 40 wt %, at least about 60 wt %, from about 25 wt % to about 90 wt % or from about 40 wt % to about 70 wt % base metal.

The target body 70 shown in FIGS. 1-3 is exemplary and it should be noted that it may include additional layers without departing from the scope of the present disclosure. Gallium may be co-deposited with other metals and/or other metals may be present in the surface layer (i.e., gallium and the base-metal may not be the exclusive materials in the surface layer 74). In some embodiments, the surface layer 74 comprises at least about 50 wt % gallium and base metal (i.e., gallium and base metal together make up about 50 wt % or more of the base layer). In other embodiments, the surface layer 74 comprises at least about 65 wt %, at least about 80 wt %, at least about 95 wt % or at least about 99 wt % of gallium and base metal. In some embodiments, the surface layer 74 consists essentially of gallium and the base metal (i.e., includes impurity levels of other materials) or even consist of gallium and the base metal.

The alloy surface layer 74 may include at least about 10 wt % gallium (all isotopes of gallium) with the remainder being base metal (e.g., nickel) or other materials. In other embodiments, the surface layer comprises at least about 25 wt % gallium or at least about 50 wt % or even at least about 65 wt % (e.g., from about 10 wt % to about 80 wt % or from about 25 wt % to about 75 wt % gallium). In one embodiment, the gallium-nickel alloy includes about 60 wt % gallium and about 40 wt % nickel. In another embodiment, the gallium-nickel alloy includes about 61 wt % gallium and about 39 wt % nickel.

After formation of the alloy, the target may be bombarded by a cyclotron or linear accelerator to cause gallium-69 to decay to germanium-68 by the (p, −2n) reaction. For example, by increasing the amount of gallium-69 in the alloy relative to gallium-71 such that at least about 90% of the gallium is gallium-69, the production of germanium-68 may be increased by 50% or more compared to natural gallium which contains 60% gallium-69.

During bombardment of the target body 70, nuclear interactions between gallium-69 and the colliding charged particles and atomic nuclei of materials of the surface layer 74 may transform a portion of those nuclei into radioisotopes such as germanium-68. Other isotopes may be produced such as Ge-69, Ge-71, Cu-62, Cu-64, Cu-61, Cu-60, Zn-62, Zn-63, Co-57 and Ga-67.

In accordance with the present disclosure, the target body 70 including the gallium-69 enriched alloy surface layer 74 is irradiated via bombardment to produce the Ge-68 radioisotope. One exemplary method of irradiation is by proton bombardment. In some embodiments of the present disclosure, the target body 70 is bombarded by a particle accelerator. For example, the proton bombardment can be accomplished by inserting the target body 70 into a linear accelerator beam at a suitable location whereby the target is bombarded at an integrated beam intensity. In some embodiments of the present disclosure, the target body 70 is bombarded with a beam current of from about 170 micro-amperes to about 300 micro-amperes, in others embodiments from about 175 micro-amperes to about 185 micro-amperes, and in other embodiments at least about 180 micro-amperes. In other embodiments, the target body 70 is bombarded with a beam current of at least about 300 micro-amperes. In some embodiments, the target body 70 is bombarded at a beam energy of from about 25.0 MeV to about 35.0 MeV, or from about 28.0 MeV to about 30.0 MeV or from about 29.0 MeV to about 29.5 MeV.

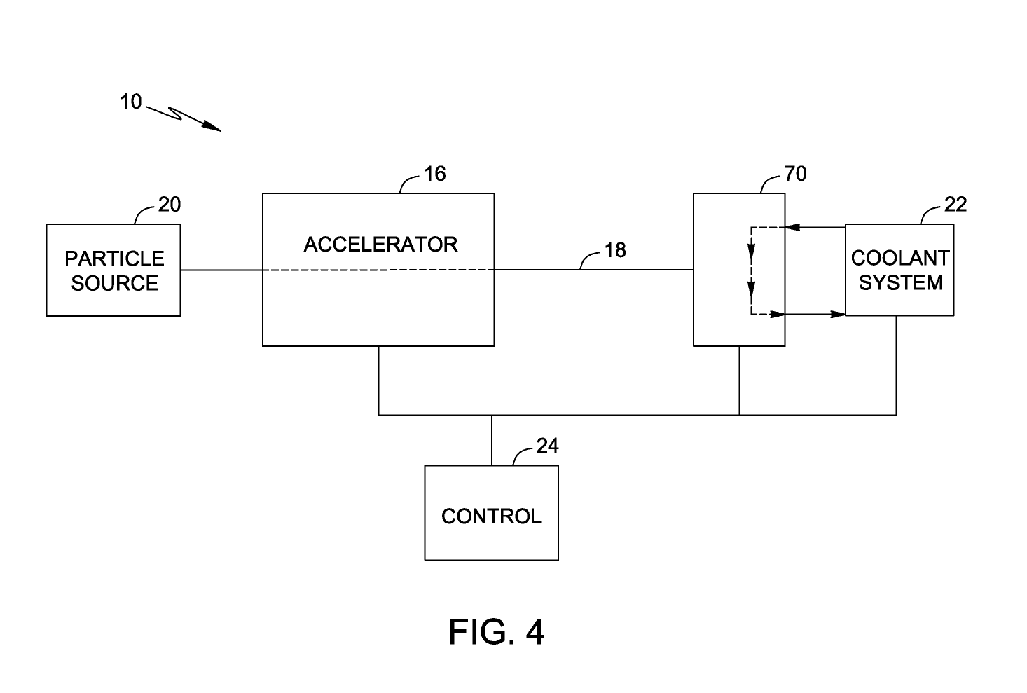

Turning now to FIG. 4, a block diagram of an exemplary particle accelerating system 10 is disclosed. The system 10 includes the target body 70 and a particle accelerator 16 configured to accelerate charged particles, as shown by line 18. The charged particles 18 accelerate to attain enough energy to produce radioisotope material once the particles 18 collide with the target body 70. Thus, the target 17 may include a mixture of germanium-68 and enriched-gallium alloy after bombardment. Production of the radioisotope is facilitated through a nuclear reaction occurring once the accelerated particles 18 interact with gallium-69. The protons 18 may originate from a particle source 20 that injects the charged particles 18 into the accelerator 16 so that the particles 18 may be accelerated towards the target body 70.

As the accelerated charged particles 18 collide with the target body 70, a substantial amount of the particles' kinetic energy may be absorbed by the target body 70. Absorption of the energy imparted by the accelerated particles 18 may cause the target body 70 to heat up. To mitigate overheating of the target body 70, the target body 70 may be coupled to a coolant system 22 disposed adjacent to the target body 70. The coolant system 22 may include fluid connectors that are fluidly coupled to the target body 70 so that fluid, such as water, may circulate along or through the target body 70, thereby removing heat absorbed by the target body 70 during irradiation of the body. In the illustrated embodiment, the coolant system 22 is shown as being separate from the target body 70 and disposed behind the target body 70. In other embodiments, the cooling system 22 may be part of the target body 70, or it may be disposed remote from the target body 70.

The particle accelerating system 10 includes a control system 24 coupled to the particle accelerator 16, the target body 70, and/or the coolant system 22. The control system 24 may be configured to, for example, control parameters, such as accelerating energy of the particles 18, current magnitudes of the accelerated charged particles 18, and other operational parameters relating to the operation and functionality of the accelerator 16. The control system 24 may be coupled to the target body 70 to monitor, for example, the temperature of the target body 70. The control system 24 may be coupled to the coolant system 22 to control temperature of the coolant and/or monitor and/or control flow rate.

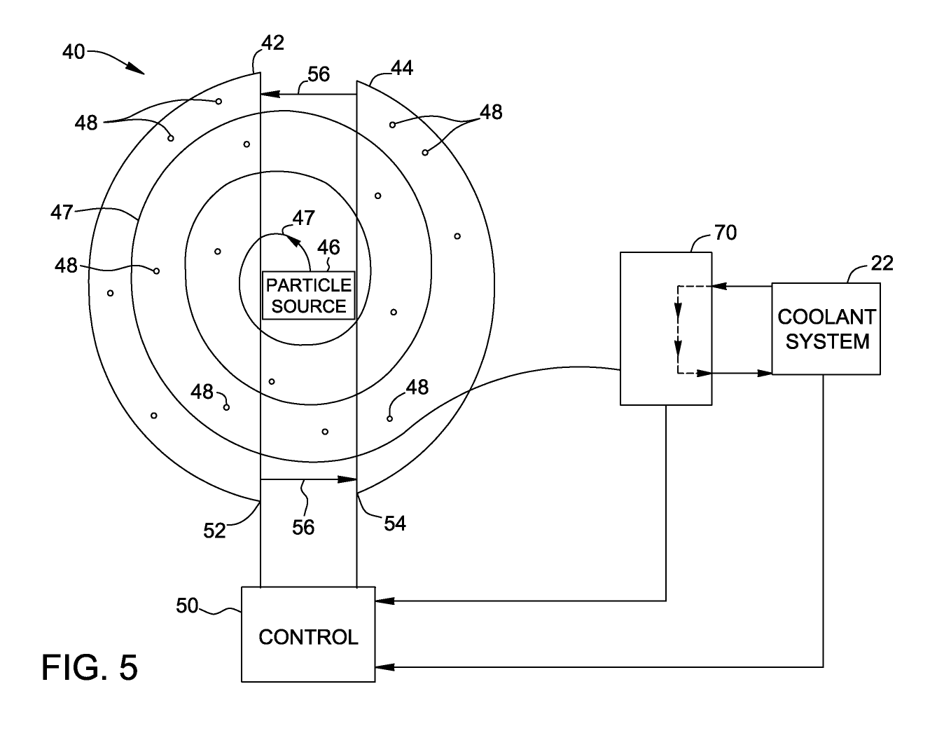

In some embodiments of the present disclosure, the particle accelerator is a cyclotron. A cyclotron can accelerate charged particles to high speeds and cause the charged particles to collide with a target to produce a nuclear reaction and subsequently create a radioisotope. Referring now to FIG. 5, an exemplary particle accelerator 40 is illustrated for use with the target body 70. The particle accelerator 40 may include a cyclotron used for accelerating charged particles, such as protons. The cyclotron 40 may employ a stationery magnetic field and an alternating electric field for accelerating charged particles. The cyclotron 40 may include two electromagnets 42, 44 separated by a certain distance. Disposed between the electromagnets 42, 44 is a particle source 46. In some embodiments, the electromagnets 42, 44 may be pie-shaped or wedge-shaped. The particle source 46 emits charged particles 47 such that the particles' 47 trajectories begin at a central region disposed between the electromagnets 42, 44. A magnetic field 48 of constant direction and magnitude is generated throughout the electromagnets 42, 44 such that the magnetic field 48 may point inward or outward perpendicular to the plane of the electromagnets 42, 44. Dots 48 depicted throughout the electromagnets 42, 44 represent the magnetic field pointing inwardly or outwardly from the plane of electromagnets 42, 44. In other words, the surfaces of the electromagnets 42, 44 are disposed perpendicular to the direction of the magnetic field.

Each of the electromagnets 42, 44 may be connected to a control 50 via connection points 52, 54, respectively. The control 50 may regulate an alternating voltage supply, for example contained within the control 50. The alternating voltage supply may be configured to create an alternating electric field in the region between the electromagnets 42, 44, as denoted by arrows 56. Accordingly, the frequency of the voltage signal provided by the voltage supply creates an oscillating electric field between the electromagnets 42, 44. As the charged particles 47 are emitted from the particle source 46, the particles 47 may become influenced by the electric field 56, forcing the particle 57 to move in a particular direction, i.e., in a direction along or against the electric field, depending on whether the charge is positive or negative.

As the charged particles 47 move about the electromagnets 42, 44, the particles 47 may no longer be under the influence of the electric field. However, the particles 47 become may become influenced by the magnetic field pointing in a direction perpendicular to their velocity. At this point, the moving particles 47 may experience a Lorentz force causing the particles 47 to undergo uniform circular motion, as noted by the circular paths 47 of FIG. 5. Accordingly, every time the charged particles 47 pass the region between the electromagnets 42, 44, the particles 47 experience an electric force caused by the alternating electric field, which increases the energy of the particles 47. In this manner, repeated reversal of the electric field between the electromagnets 42, 44 in the region between the electromagnets 42, 44 during the brief period the particles 47 traverse therethrough causes the particles 47 to spiral outward towards the edges of the electromagnets 42, 44.

Eventually, the particles 47 may impact a foil (not pictured) at a certain radius, which re-directs them tangentially into the target body 70. Energy gained while the particles 47 accelerate may be deposited into the target body 70 when the particles 47 collide with the target body 70. Consequently, this may initiate nuclear reactions within the target body 70, producing radioisotopes within the layer(s) of the target body 70. The control 50 may be adapted to control the magnitude of the magnetic field 48 and the magnitude of the electric field 56, thereby controlling the velocity and, hence, the energy of the charged particles as they collide with the target body 70. The control 50 may also be coupled to the target 70 and/or the coolant system 22 to control parameters of the target 70 and/or the coolant system 22 as described above with respect to FIG. 4.

In some embodiments of the present disclosure, the target body is bombarded for about 1 day, for about 3 days, for about 5 days, for about 7 days, for about 10 days, or for about 14 days. In one particular embodiment of the present disclosure, the target body is bombarded for about 4.4 days. The length of the bombardment can affect the radioisotope produced. In particular, prolonged bombardment of the target body will produce more of the targeted radioisotope. As used herein throughout this present disclosure, “prolonged” bombardment refers to bombardment that occurs for at least five days.

Compared to conventional target bodies, the targets of embodiments of the present disclosure have several advantages. By using alloy materials in the target surface layer that are enriched in gallium-69, the production of germanium-68 isotope may be increased. For example, use of gallium that includes at least about 90% gallium-69 may result in a 50% increase in the production of germanium-68 relative to use of natural gallium. In embodiments in which the base metal-gallium alloy is electroplated onto the target substrate plate, the amount of gallium-69 on the target may be increased relative to natural gallium which increases the germanium-68 yield.

### Example 1: Production of a Gallium-Nickel Target Body by Electroplating

A solution of gallium ions was made by dissolving 4.55 grams of gallium metal in 50 milliliters of boiling aqua regia. The mixture was boiled to near dryness to remove any residual nitric acid, and the solution was reconstituted by adding 50 milliliters of concentrated hydrochloric acid.

A cyclotron target (TR-30) was polished and placed in an electroplating cell with a platinum anode. The above solution of gallium chloride in hydrochloric acid was added to the cell and a current was generated. The target was plated at 4.0 volts and 0.82 amperes. After 30 minutes, 1 milliliter of a 4 Molar nickel chloride solution was added to the plating cell. This 1 milliliter addition was repeated every 15 minutes until the current was stopped after 2 hours and 16 minutes of plating.

Surface analysis showed the plated material to be 67% gallium and 33% nickel. The plated portion of the target was then dissolved in a solution of nitric and hydrochloric acids. ICP analysis showed the entire plated material to be 71.7% gallium and 36.3% nickel. The electroplating results are expected to be similar for use of gallium baths enriched in gallium-69.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A target body for producing geramium-68, the target body comprising:
a target substrate plate;
an alloy that forms an interface with the substrate plate, the alloy comprising:
gallium, with greater than 60% of the gallium being gallium-69; and
a base metal selected from the group consisting of nickel, iron, cobalt, copper and tungsten.

2. The target body as set forth in claim 1 wherein the base metal is nickel.

3. The target body as set forth in claim 1 wherein the target substrate plate comprises copper.

4. The target body as set forth in claim 1 wherein the alloy comprises at least about 10 wt % gallium.

5. The target body as set forth in claim 1 wherein the alloy comprises at least about 50 wt % gallium.

6. The target body as set forth in claim 1 wherein the alloy comprises at least about 75 wt % gallium.

7. The target body as set forth in claim 1 wherein the alloy comprises an amount of gallium-71, the molar ratio of gallium-69 to gallium-71 being at least about 1:1.

8. The target body as set forth in claim 1 wherein the alloy comprises an amount of gallium-71, the molar ratio of gallium-69 to gallium-71 being at least about 5:1.

9. The target body as set forth in claim 1 wherein at least about 65% of the gallium in the alloy is gallium-69.

10. The target body as set forth in claim 1 wherein at least about 95% of the gallium in the alloy is gallium-69.

11. A method for forming germanium-68, the method comprising operating a cyclotron or linear accelerator to bombard the target body as set forth in claim 1, the bombarded target decaying to produce germanium-68.

12. A method for forming a target body, the method comprising:
contacting a target substrate plate with a plating bath comprising a base metal selected from the group consisting of nickel, iron, cobalt, copper and tungsten;
contacting the target substrate plate with a plating bath comprising gallium, at least 60% of the gallium being gallium-69; and
electroplating nickel and gallium-69 onto the target substrate plate to form an alloy of base metal and gallium-69.

13. The method as set forth in claim 12 wherein the plating bath comprising a metal selected from the group consisting of nickel, iron, cobalt, copper and tungsten and the plating bath comprising gallium-69 are the same plating bath.

14. The method as set forth in claim 12 wherein the plating bath comprising a base metal selected from the group consisting of nickel, iron, cobalt, copper and tungsten is a base metal plating bath and the plating bath comprising gallium-69 is a gallium-69 plating bath that is separate from the base metal plating bath, the target substrate plate contacting the base metal plating bath and the gallium-69 plating bath in succession to alternate electroplating of gallium-69 and the base metal.

15. The method as set forth in claim 12 wherein the base metal is nickel and a nickel-gallium alloy is formed on the substrate and greater than 60% of gallium in the nickel-gallium alloy is gallium-69.

16. The method as set forth in claim 12 wherein the target substrate plate comprises copper.

17. The method as set forth in claim 12 wherein the base metal-gallium alloy comprises an amount of gallium-71, the molar ratio of gallium-69 to gallium-71 being at least about 1:1.

18. The method as set forth in claim 12 wherein the base metal-gallium alloy comprises an amount of gallium-71, the molar ratio of gallium-69 to gallium-71 being at least about 9:1.

19. The method as set forth in claim 12 wherein at least about 65% of the gallium in the gallium plating bath is gallium-69.

20. The method as set forth in claim 12 wherein at least about 85% of the gallium in the gallium plating bath is gallium-69.
